(19) United States
(12) Patent Application Publication
(10) Pub. No.: US 2013/0285787 A1
(43) Pub. Date: Oct. 31, 2013

(54) Multiple Operation Cutout

(71) Applicants: Vicente Salazar, Aguascalientes (MX); Carlos Nieto, Aguascalientes (MX); Mark W. Stavnes, Mt. Prospect, IL (US)

(72) Inventors: Vicente Salazar, Aguascalientes (MX); Carlos Nieto, Aguascalientes (MX); Mark W. Stavnes, Mt. Prospect, IL (US)

(73) Assignee: S&C ELECTRIC COMPANY, Chicago, IL (US)

(21) Appl. No.: 13/641,122

(22) PCT Filed: Apr. 19, 2011
(86) PCT No.: PCT/US11/32944

§ 371 Date: Jun. 3, 2013

Related U.S. Application Data
(60) Provisional application No. 61/325,440, filed on Apr. 19, 2010.

(51) Int. Cl. H01H 85/22

(52) U.S. Cl. CPC H01H 85/22
USPC 337/168

(57) ABSTRACT

A multiple operation cutout and a method of operating the same and providing multiple fuse operation provides an assembly for a plurality of fuses. A mechanism individually and sequentially engages the fuses responsive to operation of the fuses.

### CROSS-REFERENCE TO RELATED APPLICATIONS

This application claims benefit of U.S. Provisional Patent Application No. 61/325,440 filed Apr. 19, 2010 for all purposes and the disclosure of which is hereby expressly incorporated herein by reference.

### TECHNICAL FIELD

This patent relates to electricity distribution protection systems and in particular to multi-operation fuse cutout.

A fuse cutout is a structure that allows insertion of a fuse assembly that provides protection for an electricity distribution circuit. The fuse assembly includes a hollow insulating fuse tube having conductive ferrules mounted to the opposite ends thereof. One ferrule (often called the “exhaust” ferrule) is located at an exhaust end of the fuse tube and usually includes a trunnion that engages with a trunnion pocket or hinge of a first contact assembly carried by one end of an insulator. The other ferrule is normally held and latched by a second contact assembly carried by the other end of the insulator so that the fuse tube is normally retained in spaced relationship to the insulator. The insulator is mountable to the cross-arm of a utility pole or a similar structure. A fuse link is located within the fuse tube with its ends respectively electrically continuous with the ferrules. One point of an electrical circuit is connected to the first contact assembly, while another point of the circuit is connected to the second contact assembly. Often, the insulator and the fuse tube are oriented generally perpendicular to the ground so that the exhaust ferrule and the first contact assembly are located below the other ferrule and the second contact assembly. The fuse tube may include a high burst strength outer portion—for example, a fiber-glass-epoxy composite having an arc-extinguishing material within the inner portions thereof. Normal currents flowing through the electrical circuit flow without affecting the fuse link. Should a fault current or other over current, to which the fuse link is designed to respond, occur in the circuit, the fuse link operates.

Operation of the fuse link permits the upper ferrule to disengage itself from the upper contact assembly, whereupon the fuse tube rotates downwardly due to action of the trunnion and the hinge. If the fuse link operates properly, current in the circuit is interrupted and the rotation of the fuse tube gives a visual indication that the cutout has operated to protect the circuit, e.g. dropout operation to a so-called dropout position. Typical fuse links include a first terminal and a second terminal, between which there is normally connected a fusible element made of silver, silver-alloys, or the like. Also connected between the terminals may be a strain wire, for a purpose described below. The second terminal is electrically continuous with, and is usually mechanically connected to, a button assembly, which is engagable by a portion of the upper ferrule on the fuse tube. The first terminal is connected to a flexible, stranded length of cable. Surrounding at least a portion of the second terminal, the fusible element, the strain wire (if used), the first terminal, and some portion of the flexible stranded cable is a sheath. The sheath is typically made of a so-called ablative arc-extinguishing material which, when exposed to the heat of a high-voltage arc, ablate to rapidly evolve large quantities of deionizing turbulent and cooling gases. Typically, the sheath is much shorter than the fuse tube and terminates short of the exhaust end of the fuse tube.

The free end of the stranded cable exits the fuse tube from the exhaust end thereof and has tension or pulling force maintained thereon by a spring-loaded flipper on the trunnion. The tension or pulling force exerted on the cable by the flipper attempts to pull the cable and the first terminal out of the sheath and out of the fuse tube. The force of the flipper is normally restrained by the strain wire, typical fusible elements not having sufficient mechanical strength to resist this tension or pulling force.

In the operation of typical cutouts, a fault current or other over-current results, first, in the melting or vaporization of the fusible element, followed by the melting or vaporization of the strain wire. Following such melting or vaporization, a high-voltage arc is established between the first and second terminals within the sheath and the flipper is now free to pull the cable and the first terminal out of the sheath and, ultimately, out of the fuse tube. As the arc forms, the arc-extinguishing materials of the sheath begin to ablate and high quantities of de-ionizing, turbulent and cooling gases are evolved. The movement of the first terminal under the action of the flipper, and the subsequent rapid movement thereof due to the evolved gases acting thereon as on a piston, results in elongation of the arc. The presence of the de-ionizing, turbulent and cooling gas, plus arc elongation, may, depending on the level of the fault current or other over-current, ultimately result in extinction of the arc and interruption of the current at a subsequent current zero. The loss of the tension on the stranded cable permits the trunnion to experience some initial movement relative to the exhaust ferrule permitting the upper ferrule to disengage itself from the upper contact assembly. This initiates a downward rotation of the fuse tube and its upper ferrule to a so-called “dropout” or “dropdown” position.

As noted above, arc elongation within the sheath and the action of the evolved gases may extinguish the arc. At very high fault current or over-current levels, however, arc elongation and the sheath may not, by themselves, be sufficient to achieve this end. Simply stated, at very high fault current levels, either the sheath may burst (because of the very high pressure of the evolved gas) or insufficient gas may be evolved there from to quench the high current level arc. For these reasons, the fuse tube is made of, or is lined with, ablative arc-extinguishing material. In the event the sheath bursts, the arc-extinguishing material of the fuse tube interacts with the arc, with gas evolved as a result thereof achieving arc extinction. If the sheath does not burst, the arc-extinguishing material of the fuse tube between the end of the sheath and the exhaust end of the fuse tube is nevertheless available for evolving gas, in addition to that evolved from the sheath. The joint action of the two quantities of evolved gas, together with arc elongation, extinguish the arc.

When a fuse tube is properly positioned between the upper and lower contact assemblies of the mounting, the contacts of the fuse tube are firmly engaged within the contact assemblies of the mounting. When the fuse link operates, gases evolved within the fuse tube thrust it against the upper contact assembly of the mounting. Ideally, the contact cap should not disengage the concavity until the fusible elements of the fuse link completely melts to release the tension in the cable and until the initial thrust of the fuse tube subsides. Release of this tension and subsiding of fuse tube thrust permits a limited amount of relative movement between the exhaust ferrule and the trunnion about a toggle joint there between. This limited movement permits the contact cap to move out of the concavity and the fuse tube to begin movement toward the dropout position due to rotation of the trunnion in the hinge pocket. If the fuse tube moves too far transversely during its thrusting, the contact cap may disengage the concavity too early. Third, transverse movement of the fuse tube can apply a bending movement thereon. This bending movement can fracture the fuse tube near the exhaust ferrule. Corrosion that builds up on various parts and dimensional changes of the fuse tube or fuse link sheath, e.g. due to environmental factors, can exacerbate the proper dropout action.

Thus, it is important for achieving proper operation as explained above that dropout operation be readily achieved in spite of any deleterious operating environments or conditions.

Cutouts of the type described provide a single operation before requiring service to replace the fuse link within the fuse assembly and to reinsert the fuse assembly into the cutout. Service requires dispatching a technician to the location of the cutout, which may require significant time and expense. While the cause of the fault or over current may be transient and is in many instances, the service interruption as a result of operation of the fuse link can be protracted because of the need to service the fuse assembly.

One device that overcomes the deficiency of single operation fuse cutouts is the TripSaver® dropout recloser available from S&C Electric Company, Chicago, Ill., United States of America. The TripSaver dropout recloser incorporates a vacuum interrupter and operating mechanism capable of multiple operations before requiring service by a technician and controls to provide for automated operation. In response to a fault or over current, the TripSaver dropout recloser operates to isolate the fault and the recloses after operation to restore service. If the fault is transient, the device remains closed and service is restored without intervention by a service technician. If the fault is persistent, after a defined number of operations, the TripSaver drops out of the cutout, similar to the fuse assembly. A complete discussion of the design and operation of the TripSaver dropout recloser may be found in U.S. patent application Ser. No. 12/095,067 filed Jul. 16, 2008, the disclosure of which is expressly incorporated herein by reference.

Other attempts to provide multi-operation cutouts have included tying together two or more single cutouts. Upon operation of a fuse assembly of one of the cutouts, current is transferred to a second cutout. However, these structures have necessarily included multiple insulators, multiple moving contacts, complicated reset structures and open contract transfer operations.

### BRIEF DESCRIPTION OF THE DRAWINGS

FIG. 1 is a bottom perspective view of a multi-operation cutout in accordance with a herein described embodiment of the invention.

FIG. 2 is a top perspective view of the multi-operation cutout depicted in FIG. 1.

FIG. 3 is a front view of the multi-operation cutout depicted in FIG. 1 in a first operating state.

FIG. 4 is a bottom view of a contact mechanism in an operating position corresponding to the first operating state.

FIG. 5 is a front view of the multi-operation cutout depicted in FIG. 1 in a second operating state.

FIG. 6 is a front view of the multi-operation cutout depicted in FIG. 1 in a third operating state.

FIG. 7 is a front view of the multi-operation cutout depicted in FIG. 1 in a fourth operating state.

FIG. 8 is a perspective view of a hinge support of the contact mechanism in accordance with a preferred embodiment of the invention.

FIG. 9 is a side view of a housing member of the contact mechanism in accordance with a preferred embodiment of the invention.

FIG. 10 is a side view of a moving contact assembly of the contact mechanism in accordance with a preferred embodiment of the invention.

FIG. 11 is a side view of a trigger mechanism of the contact mechanism in accordance with a preferred embodiment of the invention.

FIG. 12 is a side view of a contact assembly of the contact mechanism in accordance with a preferred embodiment of the invention.

FIG. 13 is a side view of a spring member of the contact mechanism in accordance with a preferred embodiment of the invention.

### DETAILED DESCRIPTION

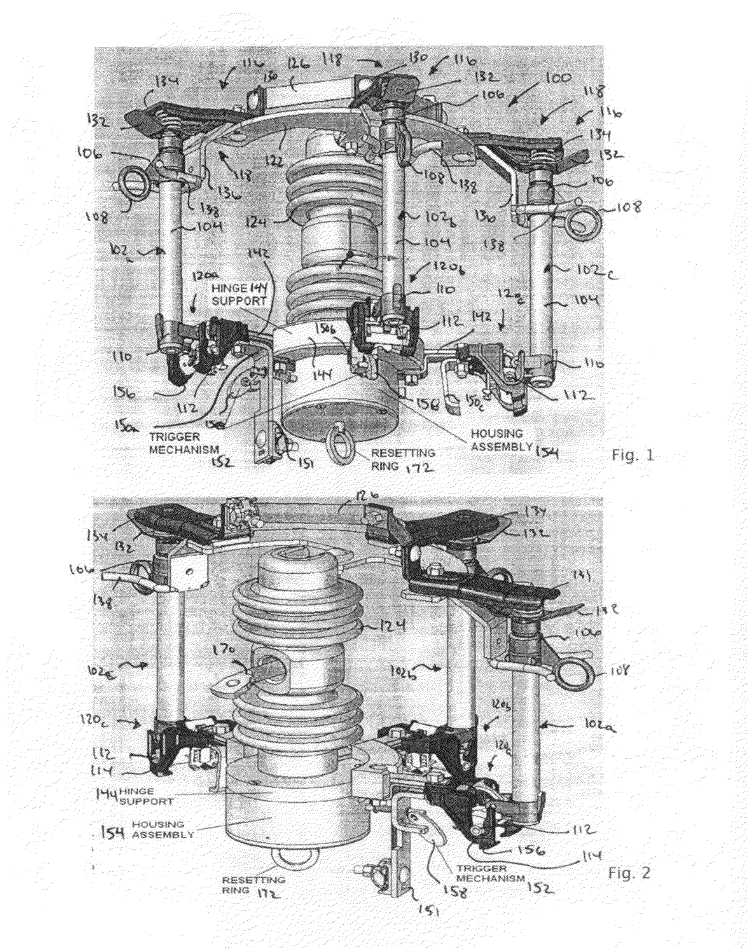

FIG. 1 depicts a multi-operation cutout 100. The cutout 100 is configured having three fuse assemblies 102 and is referred to herein as a three-shot cutout. Of course the cutout 100 may be configured to have two or more fuse assemblies 102, and the three-shot cutout 100 is shown as an illustrative example.

Except as described the fuse assemblies 102 are typical and include a fuse tube 104, a first terminal 106 that includes a grappler ring 108, a second terminal 110 that includes a trunnion 112 for fitting into a hinge 114. Corresponding in number with the fuse assemblies 102, the cutout 100 includes a plurality of fuse assembly mountings 116, which except as described are typical. Each mounting 116 includes an upper mounting assembly 118 and a lower mounting assembly 120 including hinge 114. The upper mounting assemblies 118 secure to a support bracket 122 having an as-shown arcuate shape but which may have any suitable shape that is secured to an upper portion of an insulator assembly 124. A secondary support bracket 126 is shown, and is optional, suitably secured to the upper mounting assemblies 118 at flanges 130. While identical in construction, the fuses 102 are identified as fuses 102a, 102b and 102c to facilitate description of the operating sequence.

Each upper mounting assembly 118 are part of a contact assembly 119 and includes a contact member 132 held against a respective first terminal 106 of a fuse assembly 102 by a spring 134. The contact member 132 secures to and is electrically coupled with the support bracket 122. As is typical of upper mounting assemblies, the upper mounting assembly 118 also includes a support member 136 including fuse guides 138.

Each lower mounting assembly 120 is generally similar in structure, for example, each includes hinge 114; however, each also has one or more structural and functional differences. Therefore, the three lower mounting assemblies 120 are respectively designated 120a, 120b and 120c. Each hinge 114 is secured by a bracket member 142 to a hinge support 144 secured to a lower portion of the insulator assembly 124. The trunnion 112 of a corresponding fuse assembly 102 is received in the hinge 114 allowing the fuse assembly 102 to pivot about the trunnion 112 within the hinge 114.

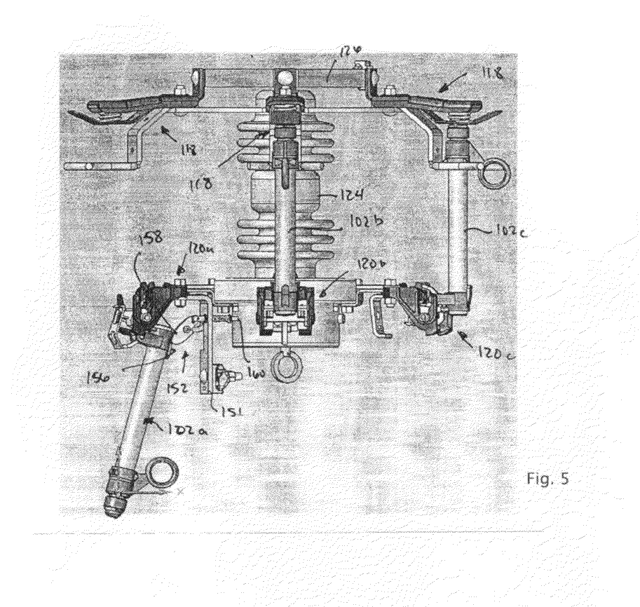

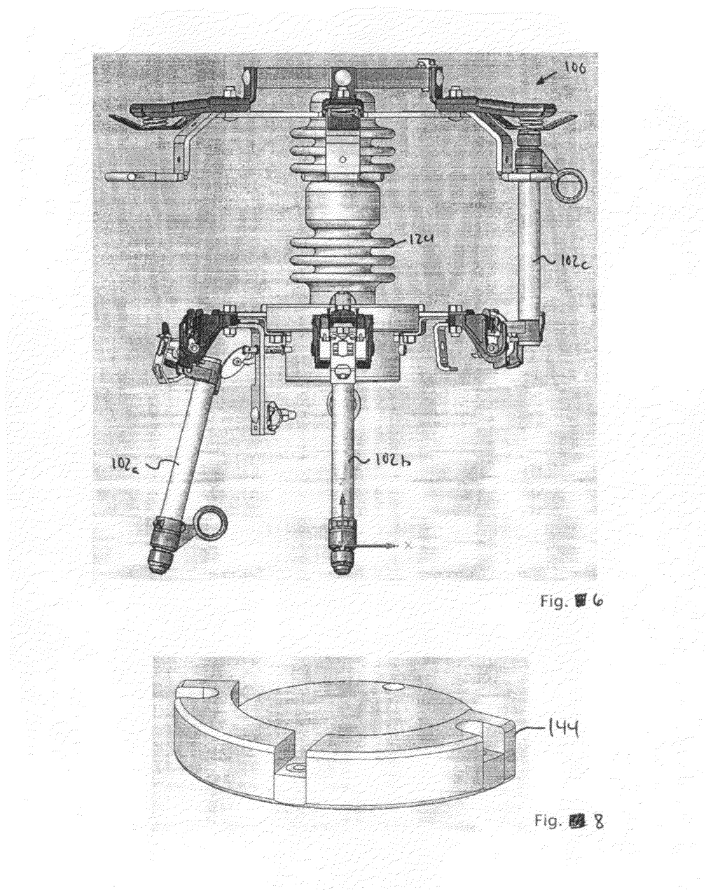

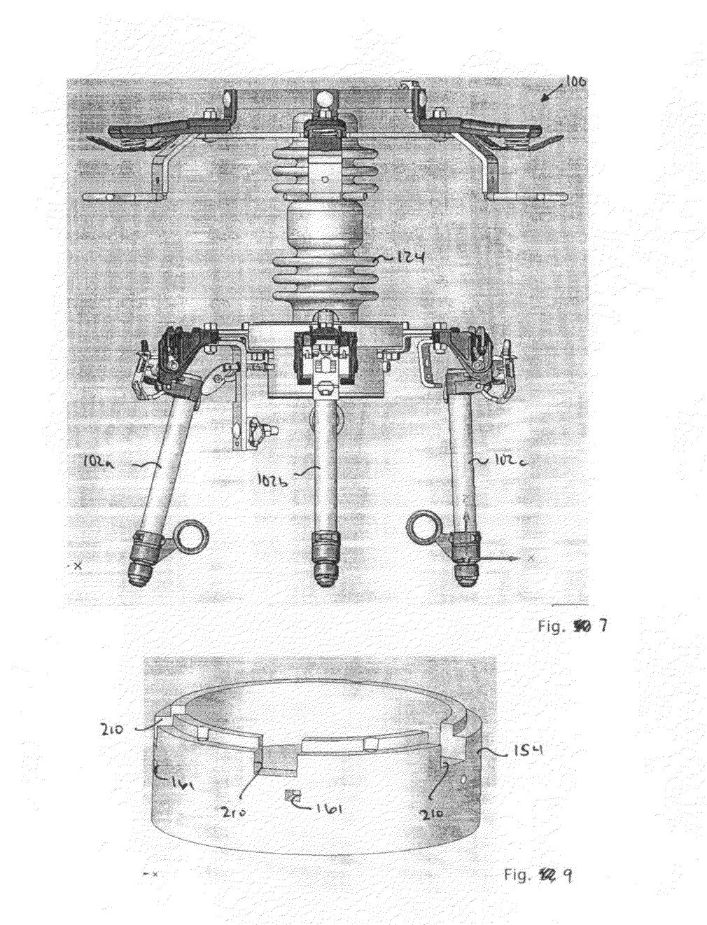

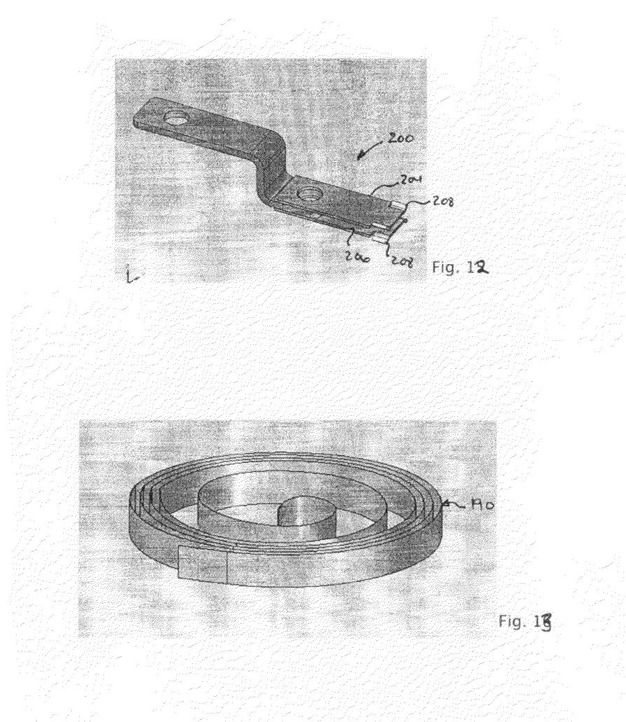

The lower mounting assembly 120a includes a bracket 150a secured to the hinge 114. The bracket 150a includes a portion 151 for electrically coupling a conductor to the cutout 100. The bracket 150a further supports and guides a trigger mechanism 152 that extends into a housing assembly 154 secured to the hinge support 144 (also seen in FIG. 8). The trigger mechanism 152 is engaged by the fuse assembly 102 as it drops out and rotates in the hinge 114 in response to clearing a fault current. A cam surface 156 is formed one the second terminal 110 that engages a rocker cam 158 of the trigger mechanism, which pivots translating a latching bar 160. The trigger mechanism 152 couples to and releases a moving contact assembly disposed within the housing assembly 154. That is, the latching bars 160 extend into the housing 154 and engage the moving contact assembly internal to the housing 154 and predetermined locations. As best seen in FIG. 4, each trigger mechanism 152 includes a spring 163 that biases the latching bar 160 such that it extends through an aperture 161 (FIG. 12) into the housing assembly 154 and is partially withdrawn by engagement of the cam surface 156 with the rocker cam 158.

The lower mounting assembly 120b includes a bracket 150b, which is similar to the bracket 150a; however, does not include the portion 151. The lower mounting assembly 120c does not include a bracket 150a or 150b as the final operating fuse assembly 102 of the cutout 100 is not required to actuate a trigger mechanism. Therefore, no trigger mechanism is provided for the last for the last fuse assembly of the cutout 100. Of course, the lower mounting assemblies 120 and/or brackets 150 may all be the same to simplify manufacturing or for other reasons.

A second conductor terminal 170 extends from a central portion of the insulator assembly 124. Additionally, extending from the housing assembly 154 is a reset ring 172 that couples to the moving contact assembly disposed within the housing assembly 154.

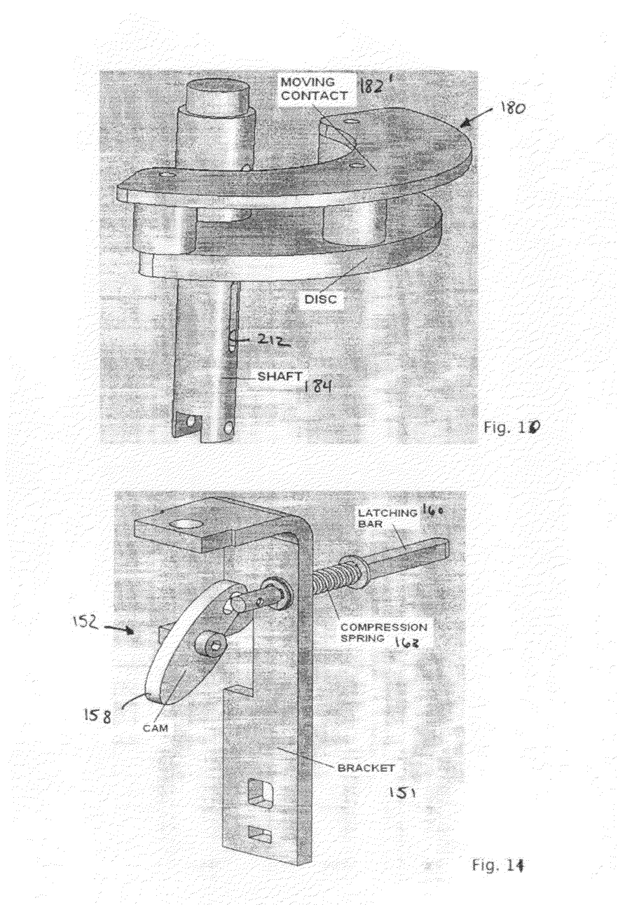

Referring to FIG. 4, a rotating contact 180 is disposed within the housing 154 and includes a plurality of conducting contact tabs 182 as part of arcuate bus 183 secured to an insulating base 185. The number of contact tabs 182 corresponds with the number of operations of the cutout 100. The rotating contact 180 is secured to a rod 184 journally supported within the housing 154 to allow rotation of the rotating contact member 180 (FIG. 10). The base 185 insulates the bus 183 and tabs 182 from the rod 184 and the housing 154. The rotating contact 180 rotates responsive to a spring bias force provided by a spring 190 (FIG. 13) engaging a slot 212 formed in the rod 184 and a slot (not depicted) in the housing 154. Also shown in FIG. 13 is an alternative rotating contact member 180a with an arcuate contact surface 192 in place of the contract tabs 182.

The contract tabs 182 engage jaw contacts 200 (FIG. 12) disposed within the housing 154 and including a conductor portion 202 that extend through slots 210 formed in the housing 154 to couple to a respective hinge 114. Each jaw contact 200 includes first and second jaw contact members 204 and 206, edges 208 of which are chamfered to guide the contact tab 182 into engagement with the jaw contact 200.

FIG. 1 illustrates the cutout 100 in a fully reset starting position. The spring 190 is charged and the reset ring 172 is in a first position corresponding with fully reset. Current flows, from the connector 170 through the upper contact assembly 119, in to the upper mountings 118 and contacts 132. Current flows through the fuse 102a to the hinge end, and the hinge 114 into the bracket 151, which is connected to the load's cable.

In response to a fault current, the fuse 102a operates, and fails out of its mounting 116 (FIG. 5). As the fuse 102a falls out of its mounting, the cam surface 156 engages the trigger cam 158 of the associated trigger mechanism. This causes the trigger cam 158 to rotate translating the latching bar 160 releases the moving contact 182 within the housing 154. The moving contact 182 is urged to move by the spring 190 and starts to rotate.

The moving contact 180 rotates to the second position, where its rotation is stopped once the contact assembly engages the latching bar of the second mounting associated with fuse 102b.

The moving contact 180 comes to rest with contact tabs 182 engaging the stationary contacts of the mountings associated with the fuses 102a and 102b at the second position. Current flows from the upper connector through the fuse 102b into its hinge 114. From the hinge 114 current flows into the associated contact 200, through the moving contact 180, which connects via the fuse 102a contact 200 and bracket 151 re-energizing the circuit.

The fault and dropout process described above is repeated causing operation of the fuse 102b (FIG. 6). Upon dropout of the fuse 102b and engagement of its associated trigger mechanism 152, the moving contact 180 again rotates and comes to rest at its fully cycled position. The moving contact 180 cannot continue any further as its rotation is stopped by a stop 210. The resetting ring 172 is the fully cycled position.

Upon occurrence of a third fault, the fuse 102c is caused to operate and drops from its mounting 116 (FIG. 7). At this point, the circuit cannot be restored without intervention of a service technician.

On arrival at the unit, the service technician removes the down fuses 102a, 102b and 102c (not the device does not need to be fully cycled to be serviced. The service technician using an appropriate tool can withdrawn unused fuse from their mountings and service the cutout 100. With the fuses withdrawn, the service technician moves the resetting ring 172 to the fully reset position, replaces the fuses 102 and engages the fuses in the mountings starting from the fuse 102c. The cutout 100 is then fully reset and the service is restored.

The operating sequence can follow a flow as follows:

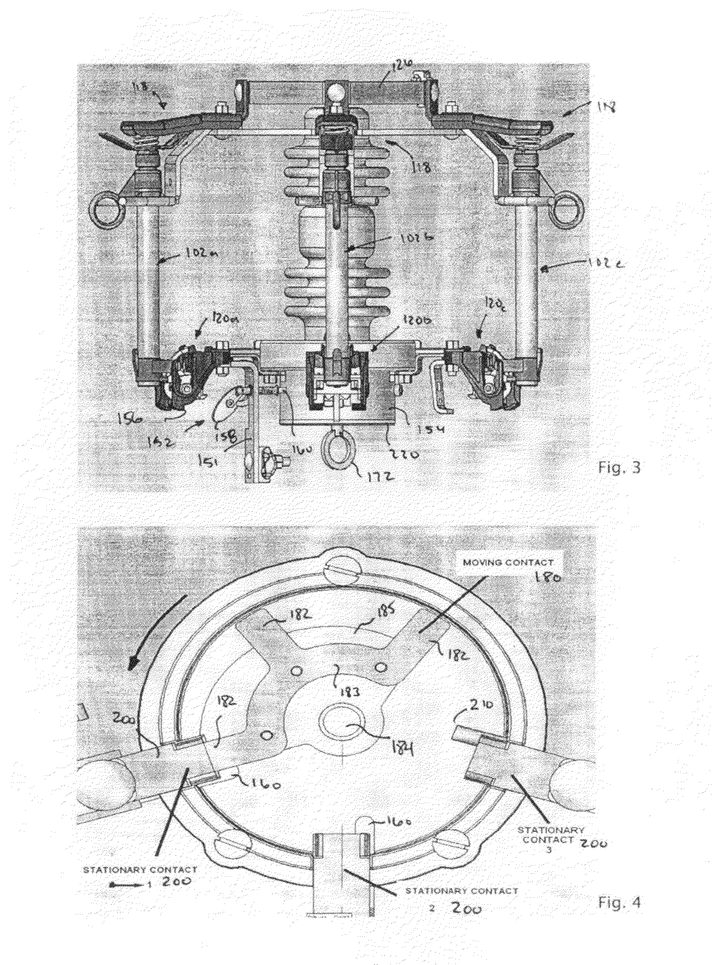

1.—Starting position (FIGS. 1-3).

2.—Fuse 102a operates and hits the associated trigger mechanism 152 which releases the latching bar 160 and allows the moving contact 180 to rotate to the stationary contact 200 of the fuse 102b (FIG. 5).

3.—Fuse 102b operates and hits its trigger mechanism 152 releasing its latching rod 160 and allowing the moving contact 180 to rotate to the stationary contact 200 of the fuse 102c (FIG. 6).

4.—Fuse 102c operates. Service of the cutout 100 is required to restore operation (FIG. 7).

5—A service technician resets moving contact 180 by rotating the resetting ring 172 recharging the spring 190 and rotating the moving contact 180 back to the fully reset portion. Fuses 102 are restored and reengaged with their associated mounting beginning with fuse 102c, then fuse 102b and finally fuse 102a, restoring service.

One of ordinary skill in the art will be able to identify and specify suitable materials, insulating or conducting as the case may be, for building and assembling the cutout 100. In one preferred embodiment, the hinge support 144 used to attach the housing assembly 154 to the insulator 124 provides mechanical and dielectric strength to support the cutout 100 operation under normal conditions and under fault conditions. It may be made of resin and uses pass trough stainless steel inserts for screws to complete assembly.

The moving contact assembly 180 transfers the path of current from one fuse 102 to another. The contact tabs 182 engage stationary contacts 200 and current is carried within the bus 183. The latching bars 160 engage the base 185 to stop rotation of the moving contact 180 on the required position. The base 183 is made of resin and provides insulation between the live parts, tabs 182 and bus 183, and the shaft 184. The tabs 182 and bus 183 carry current during the normal conditions and under fault conditions. These are made of copper, e.g., alloy C-110, or another suitable conductor. The shaft 184 holds the base 185 and engages the spring 190. It is made of a suitable structural material; for example, it may be made of stainless steel.

The housing 154 supports the moving contact assembly 180, the trigger mechanisms 156 and the load spring 190. It also provides insulation to the moving contact 180 and stationary contacts 200 and is made of a suitable structural insulator, for example, resin. An insulating, for example, resin bottom cover 220 encloses the housing 154 and prevents unnecessary access to the housing 154 and the spring 190.

The contact tab 182 bus 183 construction of the moving contact 180 allows the current path disengaged while the transition from one fuse 102 to the next is accomplished. This may reduce incidence of flashover caused by the transition. Additionally, while the moving contact 180 begins to rotate, an electrical field is forming between the stationary contacts. The structure of the moving contact 180 gives direction to the electrical field and limits its action to this part inside the housing. When the tab 182 of the moving contact 180 is approaching a stationary contact, the electrical field is more intensive on the approach side of both stationary contacts. Again, this arrangement gives direction to the forming of the electrical field and limits the action of the flashover. Contact pressure between the tab 182 and the stationary contact 200 is also controlled to avoid any hot spots or melting of the contacts causing incomplete or sticking of the rotating contact 180.

Additionally, while the structures and methods of the present disclosure are susceptible to various modifications and alternative forms, certain embodiments are shown by way of example in the drawings and the herein described embodiments. It will be understood, however, that this disclosure is not intended to limit the invention to the particular forms described, but to the contrary, the invention is intended to cover all modifications, alternatives, and equivalents defined by the appended claims.

It should also be understood that, unless a term is expressly defined in this patent using the sentence “As used herein, the term ‘_____’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Unless a claim element is defined by reciting the word “means” and a function without the recital of any structure, it is not intended that the scope of any claim element be interpreted based on the application of 35 U.S.C. §112, sixth paragraph.

We claim:

1. A multi-operation cutout for fuses for sequentially, individually coupling a plurality of fuses disposed within the cutout to an electric power circuit, the cutout comprising:
a plurality of fuse assembly mountings there being at least one mounting assembly for each fuse, each mounting assembly includes an upper mounting assembly and a lower mounting assembly including a hinge;
a first lower mounting assembly includes a bracket secured to the respective hinge and a trigger mechanism and a second lower mounting assembly includes a bracket secured to the respective hinge including a portion for electrically coupling a conductor to the cutout;
the trigger mechanism is engaged by operation of a fuse in response to clearing a fault current; and
a moving contact responsive to the trigger mechanism to sequentially couple the fuse assembly mountings to the electric power circuit.

2. The cutout of claim 1, a cam surface is formed on the first lower mounting assembly and a rocker cam is formed on the trigger mechanism, engagement of the rocker cam and the cam surface translating the moving contact.

3. The cutout of claim 1, the moving contact having a preset plurality of positions to which it moves.

4. The cutout of claim 1, a central conductor terminal disposed within an insulator housing assembly of the cutout and electrically coupled to the moving contact assembly.

5. A method providing multiple fuse operation within a cutout coupled to an electric power system, the method comprising:
providing a plurality of fuses within respective fuse mountings of the cutout;
sequentially coupling respective ones of the fuses to the electric power system.

6. The method of claim 5, wherein sequentially coupling respective ones of the fuses comprises providing a moving contact that individually and sequentially couples to the fuses and moving the moving contact through preset, predetermined positions to sequentially individually engage each of the fuses.

7. The method of claim 6, comprising triggering the moving contact to move through a preset, predetermined position upon operation of a fuse.
